(19) United States
(12) Patent Application Publication
(10) Pub. No.: US 2015/0052979 A1
(43) Pub. Date: Feb. 26, 2015

(54) LEAKAGE SIGNAL ANALYSIS METHOD

(71) Applicant: LG CNS CO., LTD., Seoul (KR)

(72) Inventors: Sang Woong CHO, Seoul (KR); Cheolsoon PARK, Seoul (KR); Sook-Ryon SEO, Seoul (KR); Jongpil AHN, Seoul (KR)

(73) Assignee: LG CNS CO., LTD., Seoul (KR)

(21) Appl. No.: 14/461,803

(22) Filed: Aug. 18, 2014

(30) Foreign Application Priority Data
Aug. 22, 2013 (KR) 10-2013-0099946

(51) Int. Cl. G01M 3/24

(52) U.S. Cl. CPC G01M 3/243
USPC 73/40.5 A

(57) ABSTRACT

A method for determining leak probability of a pipe includes receiving first and second signal data respectively for sound pressure (dB) of the pipe from a leak detection sensor operatively coupled to the pipe, the first and second signal data respectively associated with first and second time durations. The method further includes calculating a Root Mean Square (RMS) value of the first signal data for the first time duration, calculating a RMS average for the second signal data, where the second signal data includes a plurality of RMS values for the second time duration, calculating a RMS standard deviation for the second digital signal, and determining a first leak probability value based on a first excess rate of a first comparison value over the RMS standard deviation, the first comparison value being calculated based on the RMS value of the first signal data and the RMS average for the second signal data.

### CROSS-REFERENCE TO RELATED APPLICATIONS

Pursuant to 35 U.S.C. §119(a), this application claims the benefit of earlier filing date and right of priority to Korean Patent Application No. 10-2013-0099946, filed on Aug. 22, 2013, the contents of which are hereby incorporated by reference herein in their entirety.

### BACKGROUND OF THE INVENTION

1. Field of the Invention

The present invention relates to a leakage signal analysis method and more particularly to a leakage signal analysis method determining whether a leak has occurred based on a digital signal received from a leak detection sensor installed in a pipe and estimating a leak location.

2. Background of the Invention

A water pipe is often laid underground and is used for supplying water to buildings and requires suitable maintenance according to decrepit status. When the water pipe is underground, a check of the decrepit status is not always easy and water waste can be generated by a leakage of a decrepit pipe. For solving such this problem, various water leakage detectors have been developed.

Korean Patent Registration No. 10-0883446 (Feb. 5, 2009) discloses a damage detection system and method using acoustic emission. This damage detection system and method detects whether an inner structure of industrial facility is damaged in real time, effectively removing unnecessary noise from an acoustic emission signal collected on the ground and analyzing the acoustic emission signal.

Korean Patent Registration No. 10-1107085(Jan. 11, 2012) discloses a leakage detection apparatus and method. This leakage detection apparatus and method detects leakage by performing synchronization through time information received from a GPS receiver module and detects the leakage by wirelessly collecting leakage data. Therefore, the leakage detection apparatus and method may cover a wide area using a few leak detection sensors in order to decrease installation cost.

This prior art generally discloses techniques to detect whether a fault has occurred and a fault level through an analysis of an acoustic emission signal. However, this prior art does not disclose details as to how to determine whether a leak has occurred.

### SUMMARY

Embodiments of the present invention propose a leakage signal analysis method capable of determining whether a leak has occurred based on a sound wave of a pipe.

Embodiments of the present invention propose a leakage signal analysis method capable of ensuring reliability in determining whether the leak has occurred based on a sound wave of a pipe.

Embodiments of the present invention propose a leakage signal analysis method capable of estimating a leak location based on sound wave information of a plurality of sensors being transferred through a pipe when a leak has occurred in a pipe.

In some embodiments, a leakage signal analysis method is performed on a leakage signal analysis server. The method includes receiving first and second digital signals for sound pressure of a pipe from a leak detection sensor to store the first and second digital signal, the first and second digital signals respectively determined for first and second specific time durations and calculating a Root Mean Square (RMS) value of the first digital signal and a RMS average and RMS standard deviation for the second digital signal and determining a first leak probability value based on a first excess rate of a first comparison value over the RMS standard deviation, the first comparison value calculated based on the RMS value of the digital signal and the RMS average.

In one embodiment, the method may further include obtaining a frequency distribution for the first digital signal and determining a second leak probability value based on a second excess rate of a size of the first digital signal on the frequency distribution over a specific threshold.

In one embodiment, the method may further include determining a third leak probability value being inversely proportional to a correlation coefficient, the correlation coefficient calculated based on the obtained frequency distribution and a predetermined frequency distribution of a normal condition.

In one embodiment, the method may further include calculating an average value through assigning a weighted value to the first through third leak probability values and determining a fourth leak probability value based on the calculated average value.

In one embodiment, determining the first leak probability value may calculate a first similarity between the RMS value of the first digital signal and the RMS average compared to the RMS standard deviation and may determine the first leak probability value based on a difference between a reference probability value and the calculated first similarity.

In one embodiment, determining the second leak probability value may further include calculating Leak Signal Intensity (LSI) average and LSI standard deviation for a third excess rate, the third excess rate of the second digital signal over the specific threshold and determining the second leak probability value based on a second similarity, the second similarity calculated based on the first excess rate and the RMS average compared to the calculated LSI standard deviation.

In one embodiment, determining the third leak probability value may calculate Pearson's correlation coefficient between the obtained frequency distribution and the predetermined frequency distribution of the normal condition and may determine the third leak probability value based on a difference between the reference probability and the Pearson's correlation coefficient.

In one embodiment, determining the first leak probability value may further include performing a frequency filtering for the first and second digital signals.

In one embodiment, the method may further include determining whether the leak has occurred by comparing at least at least one of the first through third leak probability values and a geometric average value of a corresponding leak probability value determined for a third specific time duration.

In one embodiment, the method may further include determining whether the leak has occurred in the pipe by checking whether the fourth leak probability value exceeds a specific reference value and estimating a leak location of the pipe based on a time difference, the time difference calculated based on a first time when a specific sound pressure reaches the leak detection sensor and a second time when the specific sound pressure reaches an adjacent leak detection sensor being adjacent to the leak detection sensor when the leak has occurred.

In one embodiment, estimating the leak location may further include calculating a time dependent cross-correlation coefficient between digital signals for the sound pressure of the pipe received from the leak detection sensor and the adjacent leak detection sensor and calculating the time difference based on the calculated cross-correlation coefficient.

Herein, the cross-correlation coefficient may be calculated by using a cross correlation function.

In one embodiment, wherein estimating the leak location may estimate the leak location based on the calculated time difference and sound speed information by a pipe type.

In one embodiment, wherein estimating the leak location may calculate a moving distance of the digital signals during the time difference and may estimate the leak location based on a fourth comparison value, the fourth comparison value calculated based on the calculated moving distance and a predetermined distance between the leak detection sensor and the adjacent leak detection sensor.

In one embodiment, wherein receiving the digital signal for the sound pressure of the pipe may further include receiving an analysis request for a specific duration of the digital signal.

The summary is provided to introduce a selection of concepts in a simplified form that are further described below in the detailed description. This summary is not intended to identify key features or essential features of the claimed subject matter.

Embodiments of the present invention may determine whether a leak has occurred based on a sound wave of a pipe.

Embodiments of the present invention may ensure reliability in determining whether the leak has occurred based on a sound wave of a pipe.

Embodiments of the present invention may estimate a leak location based on sound pressure information of a plurality of sensors being transferred through a pipe when a leak has occurred in a pipe.

### BRIEF DESCRIPTION OF THE DRAWINGS

FIG. 1 is a block diagram showing a leakage signal analysis system.

FIG. 2 is a block diagram showing the leakage signal analysis server of FIG. 1.

FIG. 3 is a block diagram showing the leak service module of FIG. 2.

FIG. 4 is a flowchart illustrating an example embodiment of a leakage signal analysis method being performed on a leakage signal analysis server.

FIG. 5 is a flowchart illustrating another example embodiment of a leakage signal analysis method being performed on a leakage signal analysis server.

FIG. 6 is a graph illustrating sound pressure of a pipe on a frequency domain.

FIG. 7(a) is a graph showing cross correlation coefficients relative to time.

FIG. 7(b) is a diagram showing sensors coupled to a water pipe.

### DETAILED DESCRIPTION

Explanation of the present invention is merely an embodiment for structural or functional explanation, so the scope of the present invention should not be construed to be limited to the embodiments explained in the embodiment. That is, since the embodiments may be implemented in several forms without departing from the characteristics thereof, it should also be understood that the described embodiments are not limited by any of the details of the foregoing description, unless otherwise specified, but rather should be construed broadly within its scope as defined in the appended claims. Therefore, various changes and modifications that fall within the scope of the claims, or equivalents of such scope are therefore intended to be embraced by the appended claims.

Terms described in the present disclosure may be understood as follows.

While terms such as “first” and “second,” etc., may be used to describe various components, such components must not be understood as being limited to the above terms. The above terms are used to distinguish one component from another. For example, a first component may be referred to as a second component without departing from the scope of rights of the present invention, and likewise a second component may be referred to as a first component.

It will be understood that when an element is referred to as being “connected to” another element, it can be directly connected to the other element or intervening elements may also be present. In contrast, when an element is referred to as being “directly connected to” another element, no intervening elements are present. In addition, unless explicitly described to the contrary, the word “comprise” and variations such as “comprises” or “comprising,” will be understood to imply the inclusion of stated elements but not the exclusion of any other elements. Meanwhile, other expressions describing relationships between components such as “between”, “immediately between” or “adjacent to” and “directly adjacent to” may be construed similarly.

Singular forms “a”, “an” and “the” in the present disclosure are intended to include the plural forms as well, unless the context clearly indicates otherwise. It will be further understood that terms such as “including” or “having,” etc., are intended to indicate the existence of the features, numbers, operations, actions, components, parts, or combinations thereof disclosed in the specification, and are not intended to preclude the possibility that one or more other features, numbers, operations, actions, components, parts, or combinations thereof may exist or may be added.

The terms used in the present application are merely used to describe particular embodiments, and are not intended to limit the present invention. Unless otherwise defined, all terms used herein, including technical or scientific terms, have the same meanings as those generally understood by those with ordinary knowledge in the field of art to which the present invention belongs. Such terms as those defined in a generally used dictionary are to be interpreted to have the meanings equal to the contextual meanings in the relevant field of art, and are not to be interpreted to have ideal or excessively formal meanings unless clearly defined in the present application.

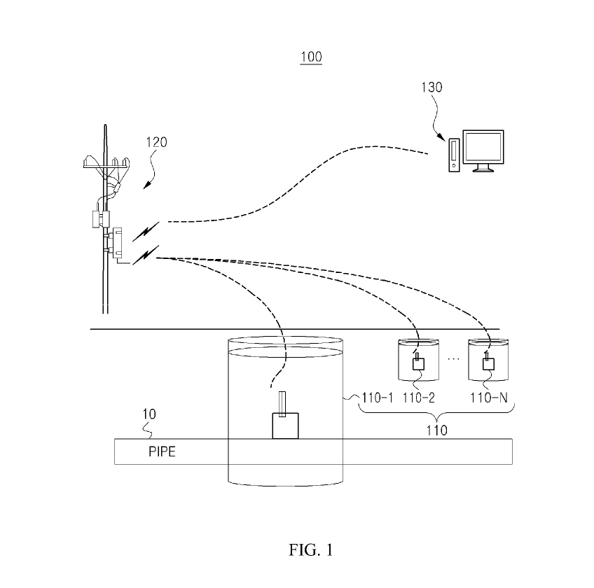

FIG. 1 is a block diagram showing a leakage signal analysis system. In this figure, the leakage signal analysis system 100 includes a leak detection sensor 110, a network device 120 and a leakage signal analysis server 130.

The leak detection sensor 110 is operated according to a plurality of sensor management modes and is installed on a pipe 10. In one embodiment, the leak detection sensor 110 is installed on the pipe 10 and is operated in a sleep mode, a standby mode, or an operation mode. Also, the leak detection sensor 110 may manually or automatically measure sound pressure of the pipe 10 according to an input or command from the leakage signal analysis server 130.

In one embodiment, the leak detection sensor 110 may supply power to a Real Time Clock (RTC) in the sleep mode to change the sensor management mode into the standby mode at a specific or desired time. The leak detection sensor 110 may supply power to a RF module (or a RF modem) and a CPU for transceiving with the network device 120 in the standby mode to start or boot the RF module (or the RF modem) and the CPU. The leak detection sensor 110 may supply the power to an sensor (e.g., an acceleration sensor, an Acoustic Emission (AE) sensor or a hydrophone), an AMP and an A/D converter for measuring the sound pressure of the pipe 10 in the operating mode.

The leak detection sensor 110 may convert the sound pressure of the pipe 10 into a digital signal through a specific network device 120 to transmit to the leakage signal analysis server 130. The leak detection sensor 110 may link the specific network device 120 with a first communication protocol to transmit the sound pressure of the pipe 10 to the specific network device 120. The first communication protocol functions with the RF module or the RF modem and the sound pressure may include data converted into the digital signal.

The network device 120 may link the leak detection sensor 110 with the first communication protocol and link the leakage signal analysis server 130 with a second communication protocol to perform a conversion between the first and second communication protocols.

In one embodiment, the network device 120 may link the leak detection sensor 110 for a maximum distance of 500 m with the first communication protocol to receive the sound pressure of the pipe 10 measured from the leak detection sensor 110, or to transmit the input or command received from the leakage signal analysis server 130 to the leak detection sensor 110. The first communication protocol may be implemented using an RF communication.

In another embodiment, the network device 120 may link the leakage signal analysis server 130 with the second communication protocol to receive the input or command measuring the sound pressure of the pipe 10 from the leakage signal analysis server 130, or to transmit the sound pressure of the pipe 10 measured from the leak detection sensor 110 to the leakage signal analysis server 130. The second communication protocol may be a mobile wireless communication protocol such as cellular or Wi-Fi, among others.

In one embodiment, the network device 120 may include a network node (e.g., a repeater) and a gateway. The network node may collect data transmitted from the leak detection sensor 110 to transmit to the gateway and may transmit the input or command of the leakage signal analysis server 130 to the leak detection sensor 110. The gateway may transmit data transmitted from the network node to the leakage signal analysis server 130 and may transmit the input or command transmitted from the leakage signal analysis server 130 to the network node.

The leakage signal analysis server 130 may collect and analyze the digital signal for the sound pressure of the pipe 10 from the leak detection sensor 110 through the network device 120 to determine whether a leak has occurred and to estimate a leak location.

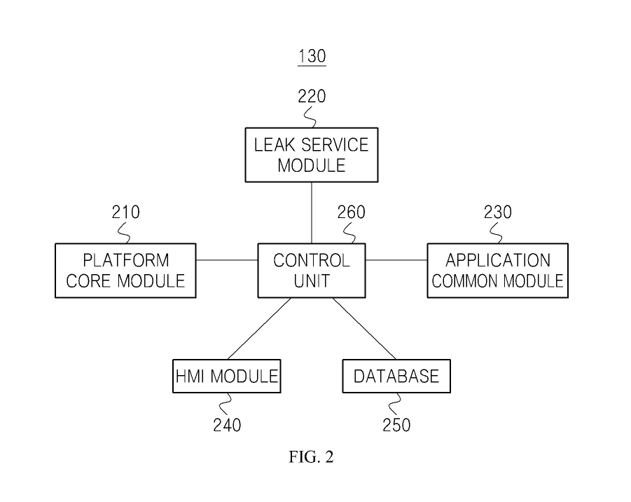

FIG. 2 is a block diagram showing the leakage signal analysis server of FIG. 1. In FIG. 2, the leakage signal analysis server 130 includes a platform core module 210, a leak service module 220, an application common module 230, a human machine interface module 240 (also referred to an HMI module), a database 250 and a control unit 260.

The platform core module 210 determines an event for information collected through the network device 120 and calls a service logic according to the event determining result. The event may be the occurring of a fault of the leak detection sensor 110 or the network device 120, or the receiving of the digital signal for sound pressure of the pipe 10 from the leak detection sensor 110. The service logic may be applied to an alarm event module or a leak analysis module. The alarm event module generates an alarm sound upon occurrence of a fault and the leak analysis module performs determining whether the leak has occurred and estimates the leak location.

The platform core module 210 may receive information of a device for management or control through the HMI module 240 to store the received information in a facility tag mapping table. The device may be the leak detection sensor 110 or the network device 120. For example, the platform core module 210 may receive information such as an identification code and an address of the device. The facility tag mapping table may be a mapping table matching information of a specific facility or a specific device to store the matched information.

The platform core module 210 may receive and register event information when registration of the event information is performed through a Human Machine Interface (HMI), and may select the service logic being performed when an identification request for an event value is received, and may call the selected service logic to leak service module 220.

The leak service module 220 classifies data collected through the platform core module 210 by a collecting reference, determines whether the leak has occurred, and estimates the leak location and stores a leak analysis result. Also, the leak service module 220 may monitor and manage a facility relevant to the leakage signal analysis system 100.

The application common module 230 integrates and provides a common function being applied in leak service module 220. The application common module 230 sets basic information such as work scope and menu management or performs message management, alarm sound management, standard operating procedure management, event information management, and integrated facility management.

The HMI module 240 provides a HMI for equipment registration and management for the leak detection sensor 110 being linked with the leakage signal analysis server 130. For example, the HMI may include a display, an audio recognition unit, an audio output unit, a keyboard, and a mouse.

The database 250 stores the facility tag mapping table, the digital signal for the sound pressure received from the leak detection sensor 110, the leak analysis result, and the standard operating procedure for the leak detection sensor 110.

The control unit 260 controls data flow among the platform core module 210, the leak service module 220, the application common module 230, the HMI module 240, and the database 250.

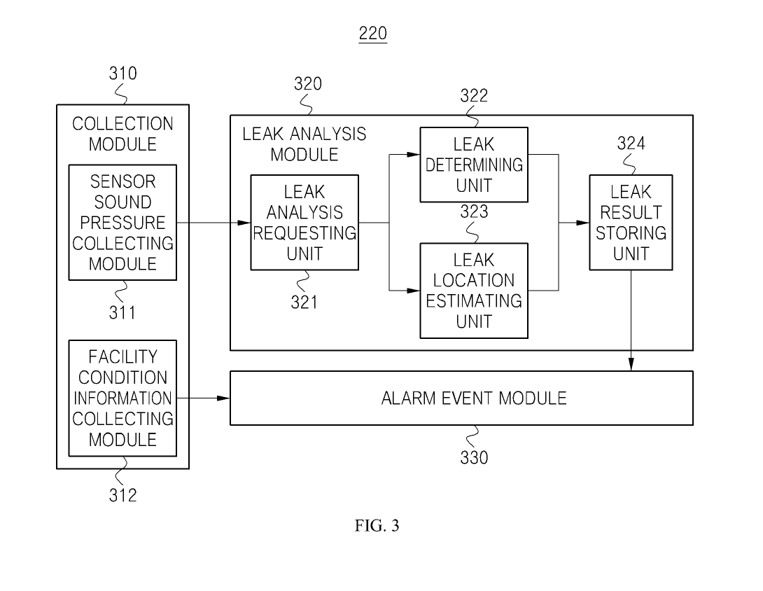

FIG. 3 is a block diagram showing the leak service module of FIG. 2. As shown in FIG. 3, the leak service module 220 includes a collection module 310, a leak analysis module 320 and an alarm event module 330.

The collection module 310 stores information relevant to a facility condition among information being collected through the platform core module 210, and generates an event according to an alarm event condition in an equipment failure and a communication error.

The collection module 310 includes a sensor sound pressure collecting unit 311 and a facility condition information collecting unit 312. The sensor sound pressure collecting unit 311 stores the digital signal for the sound pressure of the pipe and determines whether the collection module 310 calls the leak analysis module 320. The facility condition information collecting unit 312 stores information for a facility condition and provides corresponding information to the alarm event module 330 in the event of an equipment failure or a communication error.

The leak analysis module 320 determines whether a leak has occurred and estimates the leak location based on a digital signal collected through the collection module 310. The leak analysis module 320 includes a leak analysis requesting unit 321, a leak determining unit 322, a leak location estimating unit 323, and a leak result storing unit 324.

The leak analysis requesting unit 321 receives the digital signal being collected in the collection module 310 or the leak analysis request through the HMI module 240 to provide the received digital data or the leak analysis request to the leak determining unit 322 and the leak location estimating unit 323.

The leak determining unit 322 determines a leak probability value based on a digital signal when the leak determining unit 322 receives the leak analysis request. In more detail, the leak determining unit 322 determines first and second specific time durations for the digital signal. This digital signal includes a first digital signal (e.g., data signal) and a second digital signal (e.g., data signal), the first digital signal is collected in the first specific time duration and the second digital signal is collected in the second specific time duration. The leak determining unit 322 calculates a RMS value of the first digital signal and a RMS average and RMS standard deviation for the second digital signal, and determines a first leak probability value based on an excess rate of the RMS value of the first digital signal and the RMS average over the RMS standard deviation.

The first specific time duration may be a recent time collecting a digital signal for the sound pressure and the second specific time duration may be a group of specific time durations. For example, the first specific time duration may be to 2-4 hours for collecting the first digital signal for the sound pressure and the second specific time duration may correspond to a group of a plurality of 2-4 hours daily during the past 30 days or other duration

The leak determining unit 322 may calculate the RMS value corresponding to intensity of the first digital signal, the RMS average, and the standard deviation of the second digital signal according to the following Equations 1 through 3.

$${X}_{rms} = \sqrt{\frac{1}{T} * {\int }_{0}^{T} {x}^{2} ( t ) d t} \qquad Equation 1$$

where X_rms is the RMS value, x(t) is the first digital signal, and T is the first specific time duration, and

$${M}_{rms} = \frac{{\sum }_{k = 1}^{n} xk}{n} \qquad Equation 2$$

where M_rms is the RMS average, xk is the kth RMS value, and n is a number of RMS values stored during the second specific time duration, and

$${σ}_{rms} = \sqrt{\frac{{\sum }_{k = 1}^{n} {( xk - {M}_{rms} )}^{2}}{n}} \qquad Equation 3$$

where σ_rms is a RMS standard deviation.

For example, the first specific time duration may correspond to 6,000 sec, the X_rms may be a RMS value of 6,000 digital signals sampled once per 1 sec. The second specific time duration may be a time until 30 days from the first specific time duration and the RMS average and RMS standard deviation may be calculated based on 30 RMS values periodically calculated every day.

In one embodiment, the leak determining unit 322 may calculate a first similarity between the RMS value of the first digital signal and the RMS average compared to the RMS standard deviation and may determine a first leak probability value based on a difference between a reference probability value and the calculated first similarity. The reference probability value may be 1.

In more detail, the leak determining unit 322 may determine the first leak probability value according to the following Equation 4:

Pᵣₘₛ=(1−C(Xᵣₘₛ,Mᵣₘₛ,σᵣₘₛ))*100 Equation 4

where P_rms is the first leak probability value, C(X_rms, M_rms, σ_rms) is the function representing similarity between X_rms and M_rms compared to σ_rms.

The C(X_rms, M_rms, σ_rms) may be proportional to a difference between the X_rms and the M_rms (or a power of the difference), or may be inversely proportional to the σ_rms (or a power of the σ_rms). Also, the C(X_rms, M_rms, σ_rms) may represent an exponential form for a specific coefficient.

For example, when the RMS value of the first digital signal is equal to the RMS average of the second digital signal (X_rms−M_rms=0), the first leak probability value is 0%, and when a difference between the RMS value of the first digital signal and the RMS average of the second digital signal is equal to the RMS standard deviation (X_rms−M_rms=σ_rms), the first leak probability value is 50%. Therefore, when the difference between the RMS value of the first digital signal and the RMS average is increased, the leak probability value is also increased.

In one embodiment, the leak determining unit 322 may obtain a frequency distribution of the digital signal. The leak determining unit 322 may determine whether the leak has occurred on a frequency domain by obtaining the frequency distribution.

The leak determining unit 322 may obtain a frequency spectrum for the digital signal through, for example, a Fast Fourier Transform (FFT).

In one embodiment, the leak determining unit 322 may obtain the frequency distribution for the first digital signal and may determine a second leak probability value based on a second excess rate of a size of the first digital signal over a specific threshold on the frequency distribution. In more detail, the leak determining unit 322 may calculate the second excess rate, may calculate Leak signal Intensity (LSI) average and LSI standard deviation for the second digital signal, and may determine a second leak probability value based on an excess rate of a value comparing the second excess rate and the LSI average over the LSI standard deviation.

In one embodiment, the leak determining unit 322 may calculate the second excess rate according to the following Equation 5:

$${X}_{lsi} = {\sum }_{x = min}^{max} 1 , x ( f ) > L \qquad Equation 5$$

where Xlsi is the second excess rate size of first digital signal over specific threshold, f is the frequency, and L is a specific threshold.

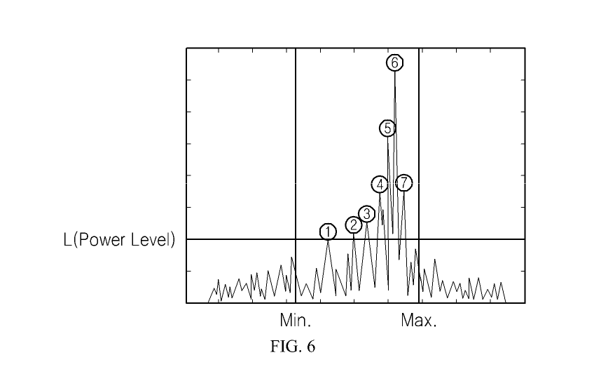

Referring ahead to FIG. 6, which is a graph illustrating sound pressure of a pipe on a frequency domain, it is shown an x-axis representing frequency and a y-axis representing sound pressure level (i.e., power level).

The leak determining unit 322 may compare a size of the digital signal corresponding to a predetermined specific frequency range (min through max) and a predetermined threshold L to calculate an excess rate of the digital signal over the predetermined threshold L. Also, the calculated excess rate may be 7.

The leak determining unit 322 may determine the second leak probability value based on the described Equations 2 through 4. In more detail, when the M_rms is changed to M_lsi, the xk applies to a kth excess rate, the n applies to a number of excess rates stored during the second specific time duration in Equation 2, and the leak determining unit 322 may calculate LSI average.

In one embodiment, the leak determining unit 322 may determine the second leak probability value based on a second similarity between the second excess rate of the first digital signal and the RMS average compared to the calculated LSI standard deviation. In more detail, the leak determining unit 322 may calculate the second leak probability value according to the following Equation 6.

Pₗₛᵢ=(1−C(Xₗₛᵢ,Mₗₛᵢ,σₗₛᵢ))*100 Equation 6

where P_lsi is a second leak probability value, C(X_lsi, M_lsi, σ_lsi) is a function representing similarity between X_lsi and M_lsi compared to σ_lsi, M_lsi is an LSI average, and σ_lsi is the LSI standard deviation.

In one embodiment, the leak determining unit 322 may calculate a correlation coefficient between the obtained frequency distribution and a predetermined frequency distribution of a normal condition to determine a third leak probability value opposing the calculated correlation coefficient.

In more detail, the leak determining unit 322 may calculate the correlation coefficient based on a frequency distribution before a specific time duration of the normal condition when the leak does not occur or the leak has occurred or an average of the frequency distribution during the second time duration.

In one embodiment, the leak determining unit 322 may calculate Pearson's correlation coefficient according to the following Equation 7″:

$${R}_{x , y} = \frac{n * Σ ( x 1 * y 1 ) - Σ x 1 Σ y 1}{\sqrt{n * Σ x {1}^{2} - {( Σ x 1 )}^{2}} * \sqrt{n * Σ y {1}^{2} - {( Σ y 1 )}^{2}}} \qquad Equation 7$$

where Rx, y is the correlation coefficient, xl is the obtained frequency distribution, and yl is the predetermined frequency distribution of normal condition.

In one embodiment, the leak determining unit 322 may determine the third leak probability value based on a difference between the reference probability value and the Pearson's correlation coefficient. In this example, the reference probability value may be 1. In more detail, the leak determining unit 322 may determine the third leak probability value according to the following Equation 8:

PCC=(1−|Rx,y|)*100 Equation 8

where PCC is the third leak probability value.

For example, when the obtained frequency distribution is similar to the predetermined frequency distribution of the normal condition, the Pearson's correlation coefficient may correspond to 1 and the third leak probability value may correspond to 0%. However when the obtained frequency distribution is different than the predetermined frequency distribution of the normal condition, the Pearson's correlation coefficient may be 0 and the third leak probability value may be 100%.

In one embodiment, the leak determining unit 322 performs frequency filtering for determining the first through third leak probability values. In more detail, the leak determining unit 322 may filter a specific frequency of the digital signal and may determine the first through third leak probability values for the filtered digital signal.

The leak determining unit 322 may change the frequency range of a digital signal being filtered to a specific value (e.g., 0) to perform the frequency filtering. For example, the leak determining unit 322 may set a through b of a frequency range as a filtering range (e.g., a through b Hz) to change the a digital signal of the corresponding filtering range to 0.

When the leak determining unit 322 performs the frequency filtering for determining the first leak probability value, the leak determining unit 322 may perform the frequency filtering after performing the FFT for the digital signal and may re-transform the filtered signal to a time domain through an inverse FFT (IFFT) to determine the first leak probability value.

In one embodiment, the leak determining unit 322 may perform the frequency filtering for at least one frequency range. For example, the leak determining unit 322 may simultaneously perform the frequency filtering for 0 Hz through 100 Hz and 10 kHz through 20 kHz. Thereby, the leak determining unit 322 may enhance reliability of determining whether the leak has occurred through filtering an ambient noise irrelevant to the leak.

In one embodiment, the leak determining unit 322 may calculate an average value through assigning a weighted value to the first through third leak probability values and may determine a fourth leak probability value based on the calculated average value. When each of the weighted values is 1, the average value may correspond to an arithmetical average, and when each of the weighted values is different than 1, the average value may correspond to an average value of the weighted values.

Thereby, the leakage signal analysis server 130 may perform multi-dimensionally and time and frequency dependently analyzing the digital signal for the sound pressure of the pipe and calculating whether the leak has occurred as the probability to enhance or otherwise guarantee reliability of the leak determination.

In one embodiment, the leak determining unit 322 may determine whether the leak has occurred in the pipe based on whether the first through fourth leak probability values exceed the specific reference value. For example, the leak determining unit 322 may check whether the first through fourth leak probability values exceed 50% and when at least one of the first through fourth leak probability values exceeds 50%, the leak determining unit 322 may determine that the leak has occurred. For another example, when the fourth leak probability values exceeds 50%, the leak determining unit 322 may determine that the leak has occurred.

In one embodiment, the leak determining unit 322 may calculate the geometric average value for at least one of the first through third leak probability values and may determine whether the leak has occurred based on a change of the geometric average. For example, the geometric average value of the first leak probability value may be calculated according to the following Equation 9.

GMᵣₘₛ=ⁿ\sqrt{P(1)ᵣₘₛ*P(2)ᵣₘₛ* . . . *P(n)ᵣₘₛ} Equation 9

where GM_rms is the geometric average value of the first leak probability value for a specific duration, n is the number of part durations included in specific duration, P(1)_rms is the first leak probability value of first part duration among the specific duration, P(2)_rms is the first leak probability value of a second part duration among the specific duration, and P(n)_rms is a first leak probability value of an nth part duration among the specific duration

The specific duration may be most any defined duration such as an hour, a day, a month, a quarter, or a year, and the part duration may correspond to a continuous specific part not overlapping each other.

For example, when the specific duration corresponds to the year 2010, the specific part duration may correspond to January through December of 2010. Also, the leak determining unit 322 may calculate a geometric average of a first leak probability value of the year 2010 and the year 2011 to determine the first leak probability value as 20% and 30% and may determine whether the leak has occurred by comparing a current first leak probability value and the geometric average value. For example, when an increased rate of the first leak probability value exceeds the specific value, the leak determining unit 322 may determine that the leak has occurred. Accordingly, the leak determining unit 322 may detect the leak being continuously proceeded according to a lapse of time.

When a leak has occurred in the pipe, the leak location estimating unit 323 estimates the leak location of the pipe based on a time difference, the time difference being calculated based on a first time when a specific sound pressure reaches the leak detection sensor and a second time when the specific sound pressure reaches an adjacent leak detection sensor being adjacent to the leak detection sensor.

In more detail, the leak location estimating unit 323 may analyze a correlation between the digital signals being measured by the two leak detection sensors through a cross correlation processor to calculate a time difference between two leak sounds being reached to the two leak detection sensors. Also, the leak location estimating unit 323 may estimate the leak location through a leak location calculator (LLC) based on the time difference between two leak sounds and sound speed information by a pipe type.

In one embodiment, the leak location estimating unit 323 may calculate the cross correlation coefficient of the two digital signals being measured by the two leak detection sensors during the specific time duration according to the following Equation 10.

R_{x,y}(t)=∫_{-∞}^{∞}x(t)*y(t+σ)*dσ Equation 10

where Rx,y is the cross correlation coefficient x(t) digital signal of first leak detection sensor, and y(t) is the digital signal of second leak detection sensor.

In one embodiment, the leak location estimating unit 323 may perform the frequency filtering for calculating the cross correlation coefficient between the two digital signals. In more detail, the leak location estimating unit 323 may perform the frequency filtering for a specific frequency range of the two digital signals and may calculate the cross correlation coefficient for the two filtered digital signals. This frequency filtering may be implemented similarly to that described above.

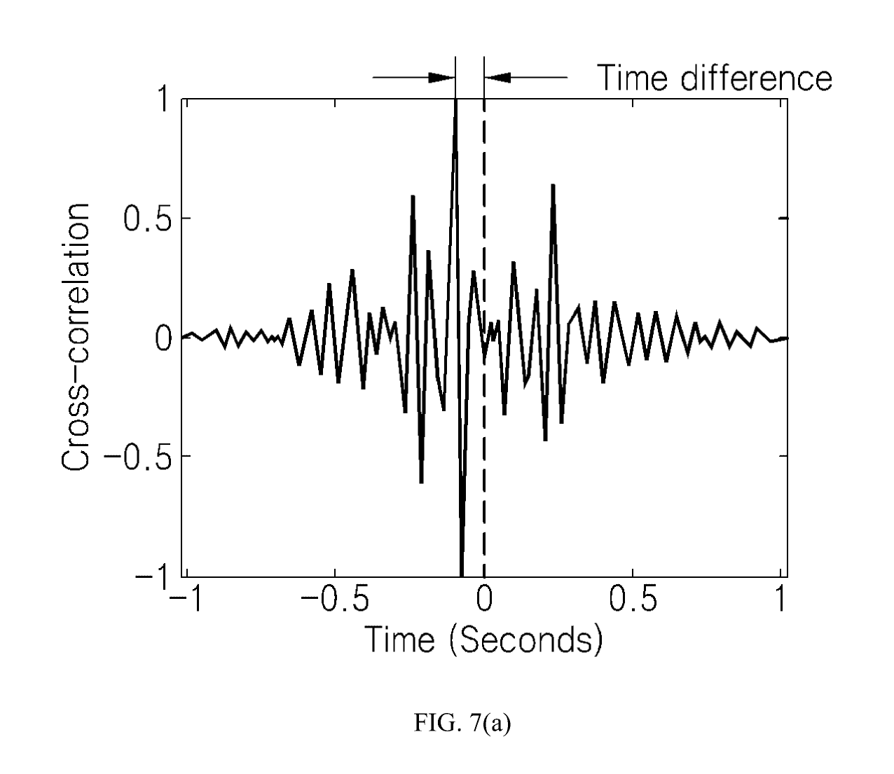

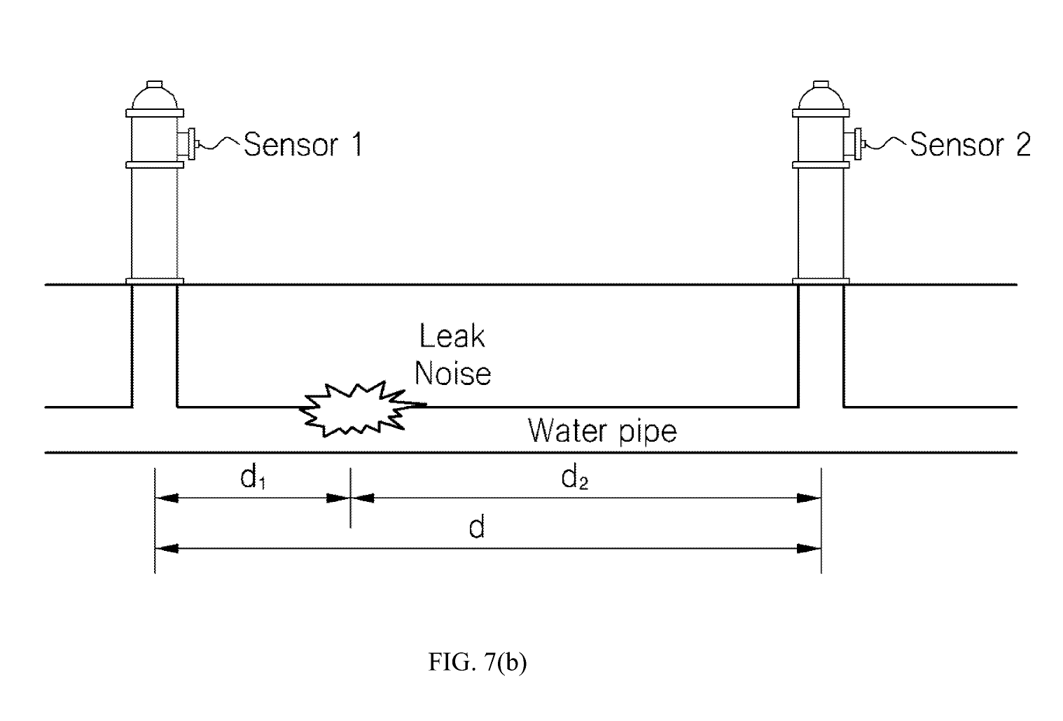

FIG. 7(a) is a graph showing the cross correlation coefficient relative to time, wherein the x-axis represents time and the y-axis represents the cross correlation coefficient. FIG. 7(b) is a diagram showing sensors coupled to a water pipe.

The cross correlation coefficient for the sound pressures being measured by the two leak detection sensors may hold at 0. However, these values may increase during a specific time duration. For instance, when a leak has occurred, two waveforms of the sound pressure being generated by the leak sound and being measured by the two leak detection sensors are similar to each other, the cross correlation coefficient is 1.

The leak location estimating unit 323 may check the time difference between the leak sounds reached on the two leak detection sensors from a cross correlation coefficient graph.

Referring to FIG. 7b, the leak sound transfers to the two leak detection sensors through the pipe from the leak location. A time when the first leak detection sensor (sensor 1) detects the leak sound does not measure the leak sound on the second leak detection sensor (sensor 2) and may measure the leak sound on the second leak detection sensor after At.

As a result, a distance (d1) from the leak location to the first leak detection sensor may be calculated based on a distance (d) between the two leak detection sensors, the sound speed (c) and the time difference (Δt) of the leak sound reached at the two leak detection sensors.

In one embodiment, the leak location estimating unit 323 may estimate the leak location based on calculating a moving distance during the time difference and comparing the distance between the two leak detection sensors with the moving distance. In more detail, the leak location estimating unit 323 may estimate the leak location according to the following Equation 11.

$$d 1 = \frac{d - c * Δ t}{2} , \\ d 2 = d - d 1 = \frac{d + c * Δ t}{2} \qquad Equation 11$$

where d1 is the distance from the leak location to first leak detection sensor, d2 is the distance from the leak location to the second leak detection sensor, d is the distance between two leak detection sensors, c is the sound speed, and Δt is time difference of leak sound reached at two leak detection sensors.

In one embodiment, the leak location estimating unit 323 may estimate the leak location based on a change of the digital signals. In more detail, the leak location estimating unit 323 may estimate the leak location based on a first change in time of the digital signal being generated according to a change of flow volume (or flow speed) being delivered though the corresponding pipe and a second change time of the digital signal being generated according to change in volume of the leak on the leak location.

In FIG. 7(b), the first leak detection sensor may measure a first change of the digital signal according to a change of the flow volume (or the flow speed) being delivered through the corresponding pipe. Also, when a change for the flow volume of the leak location occurs according to the change of the flow volume (or the flow speed), the first leak detection sensor may measure the second change of the digital signal.

The flow speed may be calculated based on the change in time of the digital signal being generated according to the change of the flow volume on the first and second leak detection sensors. The leak location may be measured based on the first change in time according to the change of the flow volume measured on the first leak detection sensor and the second change in time according to the change of the leak volume and the calculated flow speed (and the sound speed by the pipe type).

For example, a relation between the first change in time (t1) and the second change in time (t2) of the digital signals being measured on the first leak detection sensor may be represented as t1−t2=d1/V (flow speed)+d1/c (sound speed) and the flow speed (V) may be represented as V=d/(t1−t3) by a change in time (t3) of the digital signal being measured on the second leak detection sensor. Therefore, the leak location d1 may be calculated.

The leak result storing unit 324 stores a leak probability value determined in the leak determining unit 322 and information for the leak location estimated in the leak location estimating unit 323. The leak result storing unit 324 may additionally check a leak event condition to provide to the alarm event module 330 when the checked leak event corresponds to an event. The alarm event module 330 processes all alarm events being generated in the leak service module 220.

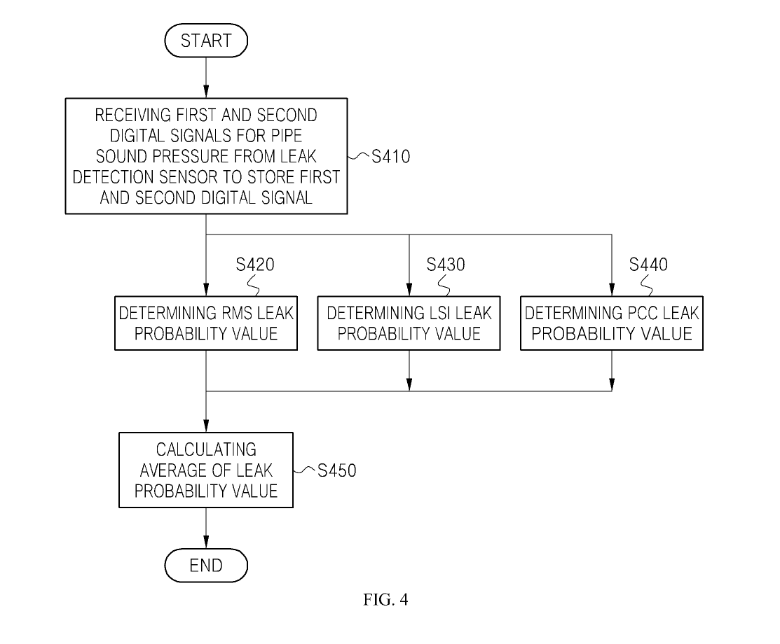

Referring back now to FIG. 4, this figure is a flowchart illustrating an example embodiment of a leakage signal analysis method being performed on a leakage signal analysis server. In this figure, the leakage signal analysis server 130 receives and stores the digital signal for the sound pressure of the pipe (block S410).

The leakage signal analysis server 130 then determines the first and second time duration and determines the first leak probability value (i.e., the RMS leak probability value) (block S420). An algorithm calculating the first leak probability value is the same as described above.

The leakage signal analysis server 130 obtains the frequency distribution for the digital signal during the first time duration (i.e., the first digital signal) and determines the second leak probability value (i.e., the LSI leak probability value) (block S430).

Also, the leakage signal analysis server 130 determines the third leak probability value based on the correlation coefficient between the obtained frequency distribution and the predetermined frequency distribution of the normal condition (block S440). An algorithm calculating the second and third leak probability values is the same as described above.

The leakage signal analysis server 130 may simultaneously or sequentially calculate the first through third leak probability values. The leakage signal analysis server 130 determines the fourth leak probability value based on the average value assigning the weighted value to the first through third leak probability values.

As a result, the leakage signal analysis server 130 may perform multi-dimensionally and time and frequency dependently analysis of the digital signal for the sound pressure of the pipe and calculate whether the leak has occurred as the probability to enhance or guarantee reliability of the leak determination.

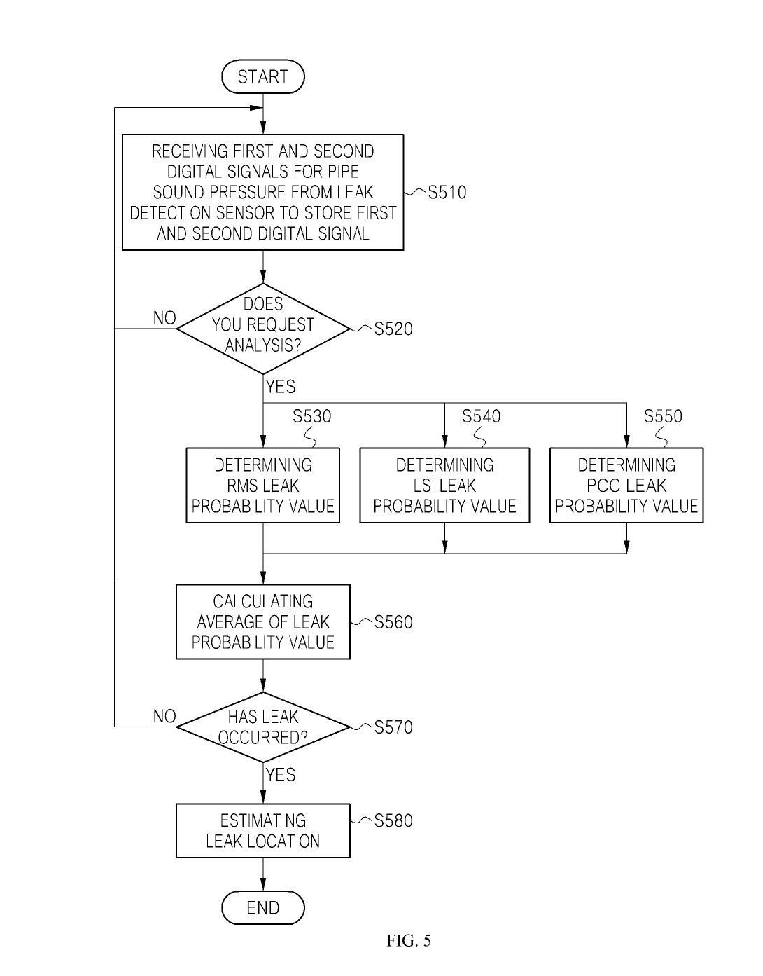

FIG. 5 is a flowchart illustrating another example embodiment of a leakage signal analysis method being performed on a leakage signal analysis server. In this figure, the leakage signal analysis server 130 receives and stores the digital signal for the sound pressure of the pipe (block S510).

The leakage signal analysis server 130 may perform a leak analysis for automatically determining whether the leak has occurred when the leakage signal analysis server 130 receives the digital signal for the sound pressure of the pipe, or may manually perform the leak analysis when the leakage signal analysis server 130 receives the leak analysis request for the specific time duration from the user (block S520).

Blocks S530 through S560 may be implemented in the same or similar manner as operations set out in blocks S420 through S450 of FIG. 4.

Referring still to FIG. 5, the leakage signal analysis server 130 may determine whether the leak has occurred by checking whether the determined leak probability value exceeds the specific reference value (block S570). When the leak has not occurred, the leakage signal analysis server 130 may wait until receiving the new digital signal or receiving the analysis request from the user.

When the leak has occurred, the leakage signal analysis server 130 estimates the leak location based on the time difference between a first time when a specific sound pressure of the pipe reaches the leak detection sensor and a second time when the specific sound pressure of the pipe reaches the adjacent leak detection sensor (block S580).

In one embodiment, the leakage signal analysis server 130 may calculate a time dependent cross-correlation coefficient between digital signals for the sound pressure of the pipe received from the leak detection sensor and the adjacent leak detection sensor, may calculate the time difference of the leak sound based on the calculated correlation coefficient, and may estimate the leak location based on the time difference and the sound speed information by the pipe type.

Although this document provides descriptions of preferred embodiments of the present invention, it would be understood by those skilled in the art that the present invention can be modified or changed in various ways without departing from the technical principles and scope defined by the appended claims.

### DESCRIPTION OF SYMBOLS

100: LEAKAGE SIGNAL ANALYSIS SYSTEM
110: LEAK DETECTION SENSOR
120: NETWORK DEVICE
130: LEAKAGE SIGNAL ANALYSIS SERVER
210: FLATFORM CORE MODULE
220: LEAK SERVICE MODULE
230: APPLICATION COMMON MODULE
240: HMI MODULE
250: DATABASE
260: CONTROL UNIT
310: COLLECTION MODULE
311: SENSOR SOUND PRESSURE COLLECTING UNIT
312: FACILITY CONDITION INFORMATION COLLECTING UNIT
320: LEAK ANALYSIS MODULE
321: LEAK ANALYSIS REQUESTING UNIT
322: LEAK DETERMINING UNIT
323: LEAK LOCATION ESTIMATING UNIT
324: LEAK RESULT STORING UNIT
330: ALARM EVENT MODULE

What is claimed is:

1. A method for determining leak probability of a pipe, the method comprising:
receiving first and second signal data respectively for sound pressure (dB) of the pipe from a leak detection sensor operatively coupled to the pipe, the first and second signal data respectively associated with first and second time durations;
calculating a Root Mean Square (RMS) value of the first signal data for the first time duration;
calculating a RMS average for the second signal data, wherein the second signal data includes a plurality of values for the second time duration;
calculating a RMS standard deviation for the second signal; and
determining a first leak probability value based on a first excess rate of a first comparison value over the RMS standard deviation, the first comparison value being calculated based on the RMS value of the first signal data and the RMS average for the second signal data.

2. The method of claim 1, further comprising:
obtaining a frequency distribution for the first signal data; and
determining a second leak probability value based on a second excess rate of a size of the first signal data on the frequency distribution over a specific threshold.

3. The method of claim 2, further comprising:
determining a third leak probability value that is inversely proportional to a correlation coefficient, the correlation coefficient calculated based on the obtained frequency distribution and a predetermined frequency distribution of a normal condition.

4. The method of claim 3, wherein the determining the third leak probability value comprises:
calculating a Pearson's correlation coefficient between the obtained frequency distribution and the predetermined frequency distribution of the normal condition; and
determining the third leak probability value based on a difference between a reference probability and the Pearson's correlation coefficient.

5. The method of claim 3, further comprising:
calculating an average value through assigning a weighted value to the first through third leak probability values; and
determining a fourth leak probability value based on the calculated average value.

6. The method of claim 3, further comprising:
determining whether a leak in the pipe has occurred by comparing at least one of the first through third leak probability values and a geometric average value of a corresponding leak probability value determined for a third specific time duration.

7. The method of claim 2, wherein determining the second leak probability value further includes
calculating Leak Signal Intensity (LSI) average and LSI standard deviation for a third excess rate, the third excess rate of the second signal data over the specific threshold; and
determining the second leak probability value based on a second similarity, the second similarity calculated based on the first excess rate and the RMS average compared to the calculated LSI standard deviation.

8. The method of claim 5, further comprising:
determining whether the leak has occurred in the pipe by checking whether the fourth leak probability value exceeds a specific reference value; and
estimating a leak location of the pipe based on a time difference, the time difference calculated based on a first time when a specific sound pressure reaches the leak detection sensor and a second time when the specific sound pressure reaches an adjacent leak detection sensor being adjacent to the leak detection sensor.

9. The method of claim 8, wherein the estimating the leak location comprises:
calculating a time dependent cross-correlation coefficient between signal data for sound pressure of the pipe received from the leak detection sensor and the adjacent leak detection sensor; and
calculating the time difference based on the calculated cross-correlation coefficient.

10. The method of claim 9, wherein the cross-correlation coefficient is calculated by using a cross correlation function.

11. The method of claim 9, wherein the estimating the leak location comprises:
estimating the leak location based on the calculated time difference and sound speed information by the type of the pipe.

12. The method of claim 9, wherein the estimating the leak location comprises:
calculating a moving distance of the first and second signal data during the time difference; and
estimating the leak location based on a fourth comparison value, the fourth comparison value calculated based on the calculated moving distance and a predetermined distance between the leak detection sensor and the adjacent leak detection sensor.

13. The method of claim 1, wherein the determining the first leak probability value comprises:
calculating a first similarity between the RMS value of the first signal data and the RMS average as compared to the RMS standard deviation for the second signal data; and
determining the first leak probability value based on a difference between a reference probability value and the calculated first similarity.

14. The method of claim 1, wherein determining the first leak probability value further includes performing frequency filtering for the first and second signal data.

15. The method of claim 1, wherein the receiving the first and second signal data comprises:
receiving an analysis request for a specific duration of the first and second signal data.
